(19) United States
(12) Patent Application Publication
(10) Pub. No.: US 2013/0194696 A1
(43) Pub. Date: Aug. 1, 2013

(54) DISK DRIVE AND WRITE CONTROL METHOD

(71) Applicants: Masakazu KITAHARA, Kunitachi-shi (JP); Minoru YAMAMOTO, Kawasaki-shi (JP)

(72) Inventors: Masakazu KITAHARA, Kunitachi-shi (JP); Minoru YAMAMOTO, Kawasaki-shi (JP)

(73) Assignee: KABUSHIKI KAISHA TOSHIBA, Tokyo (JP)

(21) Appl. No.: 13/473,420

(22) Filed: May 16, 2012

(30) Foreign Application Priority Data
Jan. 31, 2012 (JP) 2012-017981

(51) Int. Cl. G11B 21/02

(52) U.S. Cl. 360/75; G9B/21.003

(57) ABSTRACT

According to one embodiment, a disk drive writes, upon receiving a first write data block in a plurality of write data blocks having continuous logical block addresses, the first write data block in a first storage location which is included in a specific area on a disk and is adjacent to a position of the head, and writes a second write data block in a second storage location which is included in the specific area and is adjacent to the position of the head. The second storage location is a storage location skipped from the first storage location by an interval corresponding to a difference between a write completion timing of the first write data block and a reception timing of the second write data block.

### CROSS-REFERENCE TO RELATED APPLICATIONS

This application is based upon and claims the benefit of priority from prior Japanese Patent Application No. 2012-017981, filed Jan. 31, 2012, the entire contents of which are incorporated herein by reference.

### FIELD

Embodiments described herein relate generally to a disk drive and a write control method applied to this disk drive.

### BACKGROUND

In general, in a disk drive such as a hard disk drive, a buffer is used to temporarily store write data received from a host. Also, a hard disk drive capable of temporarily storing some write data in a specific storage area (a log area) on a disk has been developed.

Recently, it is demanded to improve a sequential write performance of a hard disk drive.

However, in the sequential write, if a reception timing of write data from a host is delayed, a target sector in which this write data is to be written may pass over a head position. In this case, the hard disk drive is set in a waiting state (rotation waiting state) required to wait until the target sector reaches a position under the head again by rotation of the disk. This waiting state time corresponds to that required for one rotation of the disk.

If reception timing delays of write data successively occur during the sequential write, the waiting time is lengthened, with the result that the sequential write decreases in performance.

### BRIEF DESCRIPTION OF THE DRAWINGS

FIG. 1 is an exemplary block diagram for illustrating a configuration of a disk drive according to an embodiment;

FIG. 2 is an exemplary block diagram for illustrating a configuration of a disk control program executed by the disk drive according to the embodiment;

FIG. 3 is an exemplary view for illustrating a data storage area and specific area (special area) defined on a disk in the disk drive according to the embodiment;

FIG. 4 is an exemplary view for illustrating a plurality of special areas defined on the disk in the disk drive according to the embodiment;

FIG. 5 is an exemplary block diagram for illustrating an example of a configuration of a rotation waiting detector in the disk drive according to the embodiment;

FIG. 6 is an exemplary view for explaining sequential write operation and special write operation, which are executed by the disk drive according to the embodiment;

FIG. 7 is a view for illustrating an example of a configuration of a write data management table used by the disk drive according to the embodiment;

FIG. 8 is a view for illustrating an example of a format of write data blocks to be written in the special area of the disk drive according to the embodiment;

FIG. 9 is an exemplary flowchart for illustrating a sequence of write processing executed by the disk drive according to the embodiment;

FIG. 10 is an exemplary flowchart for illustrating a sequence of special write operation executed by the disk drive according to the embodiment;

FIG. 11 is an exemplary flowchart for illustrating a sequence of sequential continuation processing executed by the disk drive according to the embodiment;

FIG. 12 is an exemplary flowchart for illustrating a sequence of write-back processing (restoration processing) executed by the disk drive according to the embodiment;

FIG. 13 is an exemplary flowchart for illustrating a sequence of write-back target data read processing executed by the disk drive according to the embodiment;

FIG. 14 is an exemplary flowchart for illustrating a sequence of write data management table initialization processing executed by the disk drive according to the embodiment; and

FIG. 15 is an exemplary flowchart for illustrating a sequence of processing executed by the disk drive at a power-on timing of the disk drive according to the embodiment.

### DETAILED DESCRIPTION

In general, according to one embodiment, a disk drive includes a disk, a head, a mechanism, and a write module. The head reads and writes data from and to the disk. The mechanism rotates the disk. The write module writes a plurality of write data blocks, which are received from a host and have continuous logical block addresses, in a plurality of storage locations spaced apart from each other in a specific area on the disk.

The write module positions the head on the specific area, writes, upon receiving a first write data block in the plurality of write data blocks, the first write data block in a first storage location. The first storage location is included in the specific area and is adjacent to a position of the head. The write module writes, upon receiving a second write data block having a second logical block address which is logically continuous to a first logical block address corresponding to the first write data block, the second write data block in a second storage location which is included in the specific area and is adjacent to the position of the head. The second storage location is a storage location which is skipped from the first storage location by an interval corresponding to a difference between a write completion timing of the first write data block and a reception timing of the second write data block.

Various embodiments will be described hereinafter with reference to the accompanying drawings.

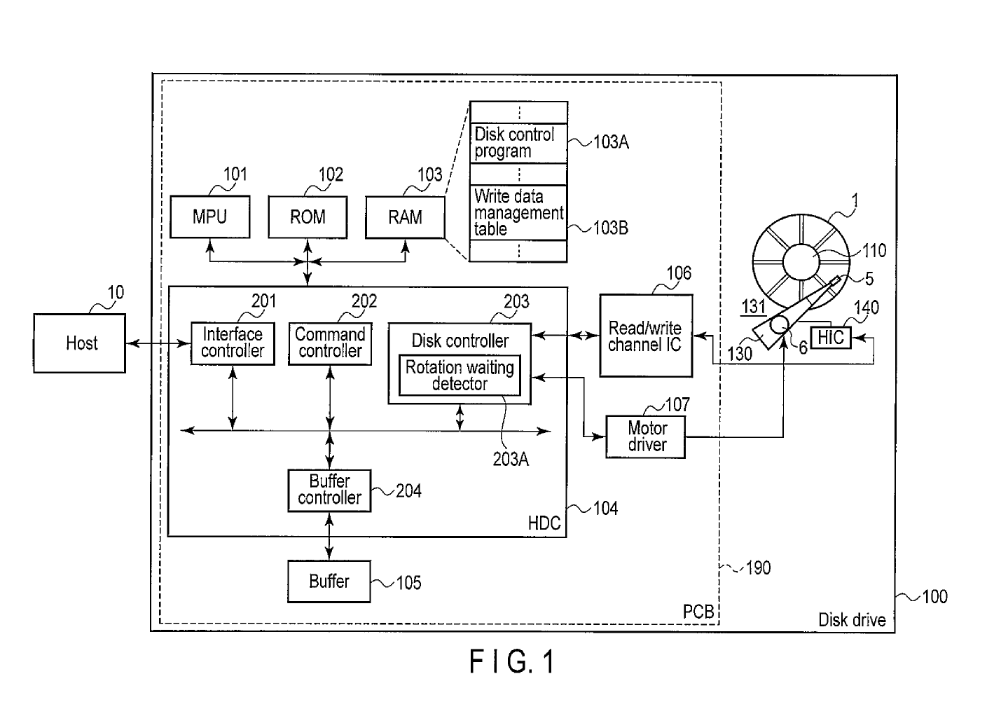

FIG. 1 is a schematic block diagram of a disk drive according to one embodiment. This disk drive 100 is mounted as a data storage device in, for example, a host such as a server computer. The disk drive 100 may be implemented as a hard disk drive. The disk drive 100 comprises a disk 1 as a magnetic disk, head 5, spindle motor 110, actuator arm 130, head amplifier (head IC) 140, and printed circuit board (PCB) 190.

The disk 1 is rotated by the spindle motor 110 at high speed. The spindle motor 110 serves as a mechanism (rotation mechanism) for rotating the disk 1. In this embodiment, a data storage area and a specific area (special area), which is different from the data storage area, are defined on the disk 1. The data storage area is a storage area used to store user data and the like. The special area is a dedicated area used to suppress decrease of the performance of sequential write operation. Logical block addresses (LBAs) are assigned to respective data storage locations (sectors) in the data storage area. On the other hand, no logical block address (LBA) is assigned to data storage locations (sectors) in the special area.

The head 5 reads and writes data from and to the disk 1. This head has a read head and write head. The read head reads a radial servo pattern and data from the disk 1. The write head writes data in each sector (each data storage location) other than a servo sector on the disk 1.

The actuator arm 130 serves as a part of a head moving mechanism 131, which moves the head 5 in the radial direction on the disk 1. The head 5 is mounted on a distal end portion of the actuator arm 130. The actuator arm 130 is supported by a pivot 6 to be pivotal about the pivot 6. The actuator arm 130 is driven by a voice coil motor (not shown). This voice coil motor drives the actuator arm 130 to position the head 5 at an arbitrary radial position on the disk 1. The voice coil motor, actuator arm 130, and the like configure the head moving mechanism 131.

The voice coil motor is controlled by a motor driver 107 mounted on the PCB 190. The head amplifier 140 amplifies a read signal from the read head in the head 5, and outputs the amplified signal to a read/write channel IC (signal processing unit) 106 mounted on the PCB 190.

On the PCB 190, a microprocessor unit (MPU) 101, a ROM 102, a RAM 103, a hard disk controller (HDC) 104, a buffer 105, the read/write channel IC 106, and the motor driver 107 are mounted. The read/write channel IC 106 is a signal processing unit which processes read/write signals.

The HDC 104 executes processing for writing write data received from a host 10 on the disk 1, and processing for reading data stored in the disk 1 and transferring the read data to the host 10 under the control of the MPU 101. When the HDC 104 receives logically continuous write commands from the host 10, the HDC 104 executes sequential write operation for sequentially writing write data blocks in a plurality of physically continuous storage locations (continuous sectors) on the disk 1 under the control of the MPU 101.

The MPU 101 is a processor (main controller) which controls the operation of the disk drive 100. The MPU 101 executes a disk control program 103A, which is loaded from the ROM 102 into the RAM 103. The disk control program 103A is a program required to control data read and write operations to the disk 1. This disk control program 103A includes a routine, which controls execution of special write operation, so as to improve the sequential write performance. The special write operation executes processing for writing respective logically continuous write data blocks received from the host 10 on the aforementioned special area at high speed. The RAM 103 also stores a write data management table 103B required to manage data (write data blocks) written on the special area. The write data management table 103B is loaded from a system area on the disk 1 into the RAM 103. The write data management table 103B is updated on the RAM 103 as a work memory. The contents of the updated write data management table 103B are backed up in the system area on the disk 1.

The HDC 104 includes an interface controller 201, command controller 202, disk controller 203, and buffer controller 204. The interface controller 201 controls data transfer between the disk drive 100 and host 10. As an interface between the disk drive 100 and host 10, for example, Serial Attached SCSI (SAS) or the like is used.

The command controller 202 executes control according to commands (write commands and read commands) received from the host 10 under the control of the MPU 101. The disk controller 203 executes control for writing write data blocks (to be also simply referred to as write data hereinafter) received from the host 10 on the disk 1, control for reading data from the disk 1, and the like under the control of the MPU 101. In this case, a write data block means write data having a variable data size. A data size of a certain write data block is designated by one write command corresponding to that write data block. A write data block received from the host 10 is temporarily stored in the buffer 105 by the buffer controller 204. Then, this write data block is read from the buffer 105 by the disk controller 203, and is supplied to the read/write channel IC 106.

The disk controller 203 further includes a rotation waiting detector 203A which detects a rotation waiting state which occurs during the sequential write operation.

This rotation waiting detector 203A detects, as the aforementioned rotation waiting state, a reception timing delay of a certain write data block in a plurality of logically continuous write data blocks during the sequential write operation. More specifically, the rotation waiting detector 203A detects that the sequential write operation is set in a waiting state (rotation waiting state) due to a reception timing delay of a certain write data block (first write data block) in a plurality of logically continuous write data blocks. The waiting state is a state of waiting until a target storage location on the data storage area corresponding to the first write data block reaches a position under the head 5 again upon rotation of the disk 1.

That is, during the sequential write operation, if the reception timing of a write data block from the host 10 is delayed, the target storage location (target start sector) in which this write data block is to be written may pass over the position of the head 5. In this case, the execution of the sequential write operation is temporarily suspended until the target storage location reaches the position under the head 5 again by rotation of the disk 1 (rotation waiting state). Occurrence of such rotation waiting state is detected by the rotation waiting detector 203A.

The reception timing delay of a write data block is likely to occur, for example, when the processing performance of the host 10 is low compared to the internal transfer rate of the disk drive 100, or when the number of command queues is small. The number of command queues indicates the number of commands (for example, write commands), which can be held in a command queue in the disk drive 100.

If the number of command queues is set to be one, the disk drive 100 returns a response for notifying the host 10 of write completion to the host 10 every time a write operation of a write data block corresponding to one write command is complete. Before reception of the write completion response, the host 10 does not transmit a next write command and a write data block corresponding to the next write command to the disk drive 100. Therefore, the reception timing of a write data block is likely to be delayed.

If the number of command queues is set to be four, the disk drive 100 returns, to the host 10, a response for notifying the host 10 of write completion of four write data blocks corresponding to four successive write commands upon completion of write operations of these four write data blocks. Upon reception of the write completion response, the host 10 can sequentially transmit next four write commands and four write data blocks corresponding to these four write commands to the disk drive 100.

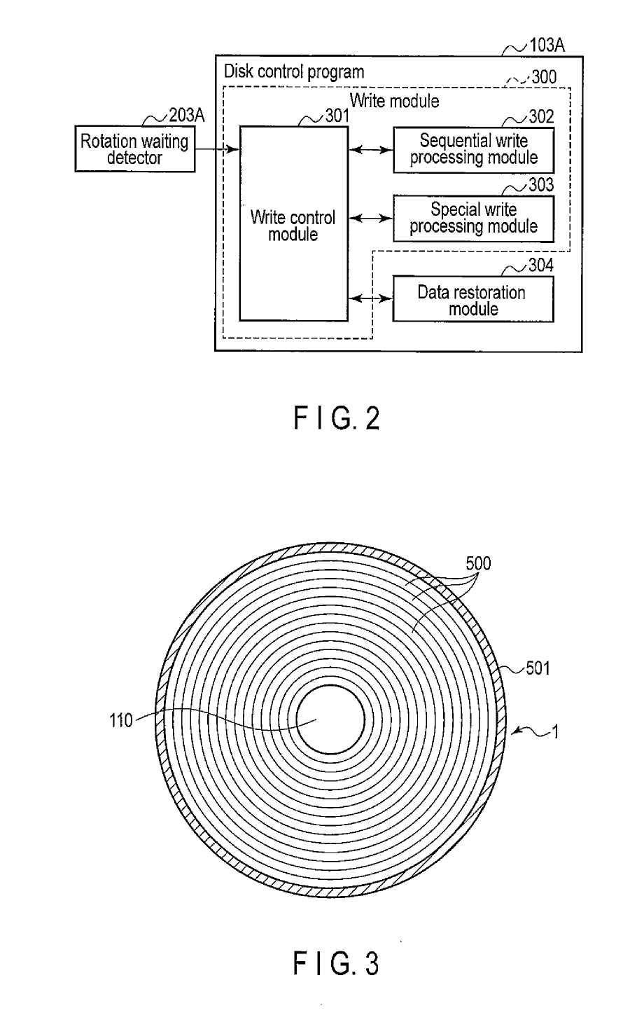

The functional arrangement of the disk control program 103A will be described below with reference to FIG. 2. The disk control program 103A includes, as modules required to implement its functions, a write control module 301, sequential write processing module 302, special write processing module 303, and data restoration unit 304. The write control module 301, sequential write processing module 302, and special write processing module 303 configure a write module 300 for writing a plurality of logically continuous write block data received from the host 10 to the disk 1. The write module 300 has a sequential write mode and special write mode, as write modes for writing a plurality of logically continuous write block data to the disk 1. In the sequential write mode, the aforementioned sequential write operation for sequentially writing a plurality of write data blocks in continuous data storage locations in the data storage area on the disk 1 is executed. In this case, the plurality of write data blocks are respectively written in the continuous data storage locations in the data storage area, to which logical block addresses of these plurality of write data blocks are assigned. In the special write mode, the plurality of write data blocks are written in a plurality of storage locations, which are spaced apart from each other in the special area on the disk 1.

In the sequential write mode, when the reception timing delay (rotation waiting state) of a certain write data block in a plurality of logically continuous write data blocks is detected, the write module 300 shifts the write mode from the sequential write mode to the special write mode.

The sequential write processing module 302 serves as a first write module which executes the aforementioned sequential write operation in cooperation with the HDC 104. This sequential write processing module 302 executes sequential write operation for sequentially writing a plurality of logically continuous write data blocks, that is, a plurality of write data blocks, which are received from the host 10 and have continuous logical block addresses, in physically continuous storage locations in the data storage area on the disk 1.

If the rotation waiting detector 203A detects the aforementioned waiting state (rotation waiting state) during execution of the sequential write operation, the write control module 301 activates the special write processing module 303 in place of the sequential write processing module 302. In other words, the write control module 301 changes the write mode of the write module 300 from the sequential write mode (first write mode) to the special write mode (second write mode).

The special write processing module 303 is a write module which writes a plurality of logically continuous write data blocks, that is, a plurality of write data blocks, which are received from the host 10 and have continuous logical block addresses, in a plurality of storage locations, which are spaced apart from each other in the special area on the disk 1. The special write processing module 303 positions the head 5 on the special area, and executes special write operation for writing a plurality of logically continuous write data blocks in the special area.

In the special write accesses, the special write processing module 303 writes a certain write data block (first write data block) in the plurality of write data blocks in a quickest write-accessible storage location (first storage location) in the special area, irrespective of a start LBA of the first write data block, upon receiving the first write data block from the host 10. The quickest write-accessible first storage location in the special area is that which is included in the special area and is adjacent to the current position of the head 5 (for example, a storage location adjacent to a position immediately before the current position of the head 5). The special write processing module 303 decides a quickest write-accessible sector in the special area, that is, a quickest trackable sector in the special area, based on the current position of the head 5 which is positioned in the special area, and writes the first write data block in a storage location starting with the decided sector.

Furthermore, in the special write operation, the special write processing module 303 also writes, in the special area, a second write data block having a second logical block address (start LBA), which is logically continuous to a first logical block address (start LBA) of the first write data block. For example, assume that Start LBA of the first write data block is 2, and the data size of the first write data block is 10 blocks (=10 sectors). In this case, if a start LBA designated by a next write command, that is, that of the second write data block is 12, it is determined that Start LBA of the second write data block is logically continuous to that of the first write data block.

Upon reception of this second write data block, the special write processing module 303 writes the second write data block in a quickest write-accessible storage location (second storage location) in the special area irrespective of Start LBA of the second write data block. The quickest write-accessible second storage location in the special area is a storage location which is included in the special area and is adjacent to the current position of the head 5 (for example, a storage location adjacent to a position immediately before the current position of the head 5). The special write processing module 303 decides a quickest write-accessible sector, that is, a quickest trackable sector in the special area, based on the current position of the head 5 which is positioned on the special area, and writes the second write data block in a storage location starting with the decided sector.

Since the disk 1 is rotated at high speed, a storage location adjacent to the current position of the head 5 on the special area, that is, a sector number on the special area corresponding to the current position of the head 5, is changed as an elapse of time. Therefore, the second storage location is that which is skipped from the first storage location by an interval (skip width) corresponding to a difference between the write completion timing of the first write data block and the reception timing of the second write data block.

Furthermore, the special write processing module 303 also writes, in the special area, a third write data block having a third logical block address (start LBA), which is logically continuous to the second logical block address (start LBA) corresponding to the second write data block.

Upon reception of this third write data block, the special write processing module 303 writes the third write data block in a quickest write-accessible storage location (third storage location) in the special area irrespective of Start LBA of this third write data block. The third storage location is that which is skipped from the second storage location by an interval (skip width) corresponding to a difference between the write completion timing of the second write data block and the reception timing of the third write data block.

In this manner, in the special write operation, each of the plurality of logically continuous write data blocks, which can be sequentially written, is written in a storage location in the special area which is included in the specific area and is adjacent to the current position of the head 5, irrespective of the LBA of that write data block. Thus, the plurality of write data blocks are respectively written in a plurality of storage locations which are spaced apart from each other in the special area. Thus, in the special write operation, the aforementioned waiting state, which waits for rotation of the disk 1, never occurs. Therefore, even if the number of command queues is set to be, for example, one, a plurality of logically continuous write data blocks can be written in the disk 1 at high speed. In this manner, the sequential write performance of the disk drive 100 can be improved.

Note that in the above description, when occurrence of the rotation waiting state is detected during the sequential write accesses (in the sequential write mode), the write mode is changed from the sequential write mode to the special write mode. As described above, when the number of command queues is set to be a small value, the rotation waiting state occurs with a high possibility. Therefore, the special write mode may be preferentially used as a write mode for writing logically continuous write block data.

Write information (a start LBA, data size, skip width, and the like) associated with each write data block written in the special area may be stored in the write data management table 103B. Alternatively, a write data block appended with this write information may be written in the special area. Based on this write information, data designated by a read command from the host 10 can be read from the special area. Also, each write data block written in the special area may be restored (returned) to an original storage location on the data storage area based on the logical block address (start LBA) of that write data block.

The data restoration unit 304 executes this restoration processing, that is, processing for restoring each write data block written in the special area to an original storage location on the data storage area (to be also referred to as write-back processing hereinafter). That is, the data restoration unit 304 respectively restores the first write data block, the second write data block and the third write data block written in the special area to storage locations in the data storage area, to which the logical block addresses of these first, second, and third write data blocks are assigned.

An example of the special area on the disk 1 will be described below with reference to FIG. 3. As shown in FIG. 3, a plurality of concentric tracks 500 are defined on the disk 1. Each track 500 includes a plurality of sectors. The number of sectors included in each track on the outer periphery side of the disk 1 is larger than that included in each track on the inner periphery side of the disk 1. Therefore, a transfer rate required to make data read and write accesses to a storage area on the outer periphery side of the disk 1 is higher than that required to make data read and write accesses to a storage area on the inner periphery side of the disk 1.

One or more specific tracks on the disk 1 are used as a special area 501. FIG. 3 shows a case in which an outermost track having a highest transfer rate is used as the special area 501. Note that the special area 501 may include a plurality of special areas distributed on the disk 1. These special areas are located to be spaced apart from each other on the disk 1. Each special area includes one or more tracks. No logical block address is assigned to any storage location in the special area 501. All tracks other than those used as the special area 501 are used as the data storage area. A part of the data storage area is used as the system area required to store management data and the like, and another part of the data storage area is used as the user data area required to store user data.

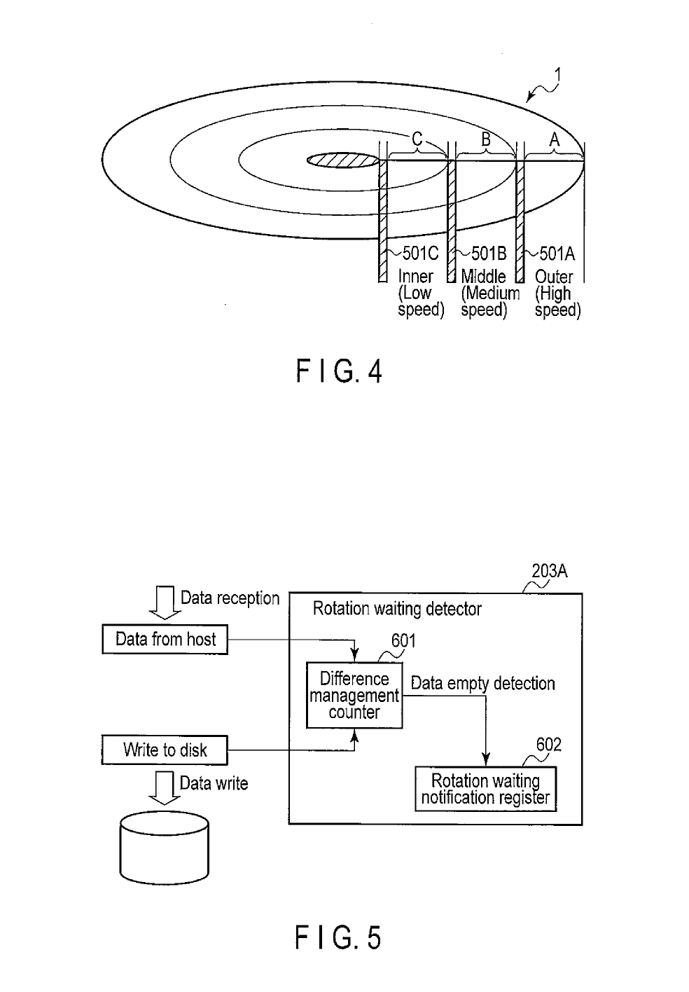

Note that the plurality of concentric tracks 500 may be grouped into a plurality of zones. FIG. 4 assumes a case in which the concentric tracks 500 are divided into three zones, that is, a zone A corresponding to an outer area, a zone B corresponding to a middle area, and a zone C corresponding to an inner area. Data transfer rates are different for respective zones. The data transfer rate of zone A is highest, and that of zone C is lowest.

One or more tracks of the tracks 500 which belong to zone A may be used as a special area 501A. Likewise, one or more tracks of the tracks 500 which belong to zone B may be used as a special area 501B. Likewise, one or more tracks of the tracks 500 which belong to zone C may be used as a special area 501C.

A special area used for the special write operation can be selected from the three special areas 501A, 501B, and 501C. For example, of the three special areas 501A, 501B, and 501C, a special area, which is most adjacent to a track as a current sequential write operation target, is selected as that used for the special write operation. Then, since a moving amount of the head 5 in the radial direction, which is required to shift the write mode from the sequential write mode to the special write mode can be minimized, a time required to change the write mode can be shortened.

An example of the arrangement of the rotation waiting detector 203A will be described below with reference to FIG. 5. The rotation waiting detector 203A is a detection unit which detects occurrence of a reception timing delay of a write data block. This rotation waiting detector 203A may be implemented by a difference management counter 601 and rotation waiting notification register 602.

The different management counter 601 manages a size of remaining write data in the buffer 105. For example, when a write data block having a data size of 10 blocks (=10 sectors) is received from the host 10, the difference management counter 601 increments a current count value, which indicates the size of remaining write data in the buffer 105, by 10. On the other hand, every time write operations of the write data as many as the predetermined number of sectors on the disk 1 are complete, the difference management counter 601 decrements the current count value by the predetermined number of sectors. When the current count value reaches zero, the difference management counter 601 sets status data indicating occurrence of a rotation waiting state in the rotation waiting notification register 602, thereby notifying the MPU 101 of occurrence of the reception timing delay of a write data block, that is, a rotation waiting state.

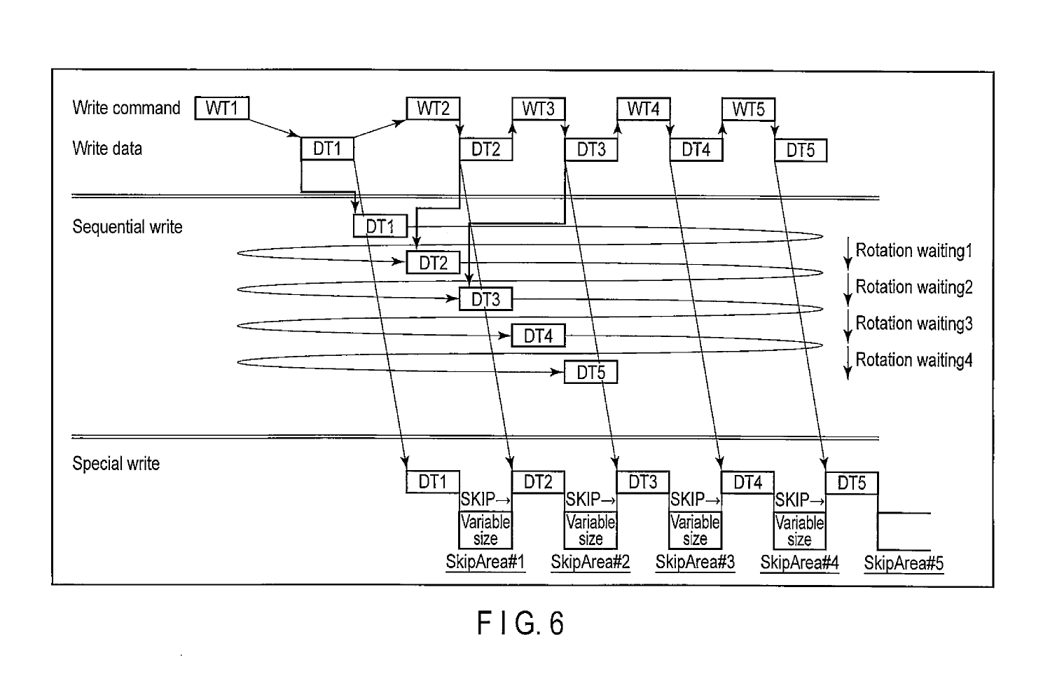

The sequential write operations and special write operations will be described below with reference to FIG. 6.

In FIG. 6, assume that the aforementioned number of command queues is one. Five write commands WT1 to WT5 are logically continuous write commands. In this case, sequential write operation for a certain single track is executed.

A write data block DT1 corresponding to write command WT1 is written in a data storage location assigned with an LBA (start LBA) designated by write command WT1. More specifically, write data block DT1 is written in a sector group starting with a sector assigned with an LBA (start LBA) designated by write command WT1. Upon completion of the write operation of write data block DT1, the MPU 101 returns a response indicating write completion to the host 10.

The host 10 transmits write command WT2 and a write data block DT2 to the disk drive 100. When write data block DT2 is received, a target storage location where write data block DT2 is to be written may have already passed over a position under the head 5. In this case, the MPU 101 suspends the sequential write operation until the target storage location reaches the position under the head 5 again.

Therefore, if the sequential write operation is continued intact without changing the write mode, the writing of logically continuous five write data blocks DT1 to DT5 require a time corresponding to five revolutions of the disk 1.

In the special write operation, the five write data blocks DT1 to DT5 are written on the special area 501, that is, on a certain single track (specific track) in the special area 501 to be spaced part from each other by a certain skip interval.

More specifically, when write data block DT1 is received, the MPU 101 executes control to decide a storage location (a sector adjacent to the current position of the head 5) for which a write operation can be started earliest in the special track, and to write the write data block DT1 in this storage location. Upon completion of the write operation of write data block DT1, the MPU 101 returns a response indicating write completion to the host 10. The host 10 transmits write command WT2 and a write data block DT2 to the disk drive 100.

When write data block DT2 is received, the MPU 101 executes control to decide a storage location (a sector adjacent to the current position of the head 5) for which a write operation can be started earliest in the special track, and to write the write data block DT2 in this storage location. Upon completion of the write operation of write data block DT2, the MPU 101 returns a response indicating write completion to the host 10. The host 10 transmits write command WT3 and a write data block DT3 to the disk drive 100.

In the aforementioned special write operation, the aforementioned rotation waiting state required to wait for the rotation of the disk 1 does not occur. Furthermore, a seek operation for moving the head 5 in the radial direction need not be executed. Therefore, the write accesses of the logically continuous five write data blocks DT1 to DT5 are completed within a time corresponding to one revolution of the disk 1. Hence, the logically continuous five write data blocks DT1 to DT5 can be written in the special area (special track) on the disk 1 at higher speed than the sequential write operation.

Write data blocks DT1 to DT5 written in the special track may be written back to original storage locations on the data storage area later. After completion of write-back operations of write data blocks DT1 to DT5, the special track can be used for new special write operation again. In this case, a new write data block is overwritten on an old write data block.

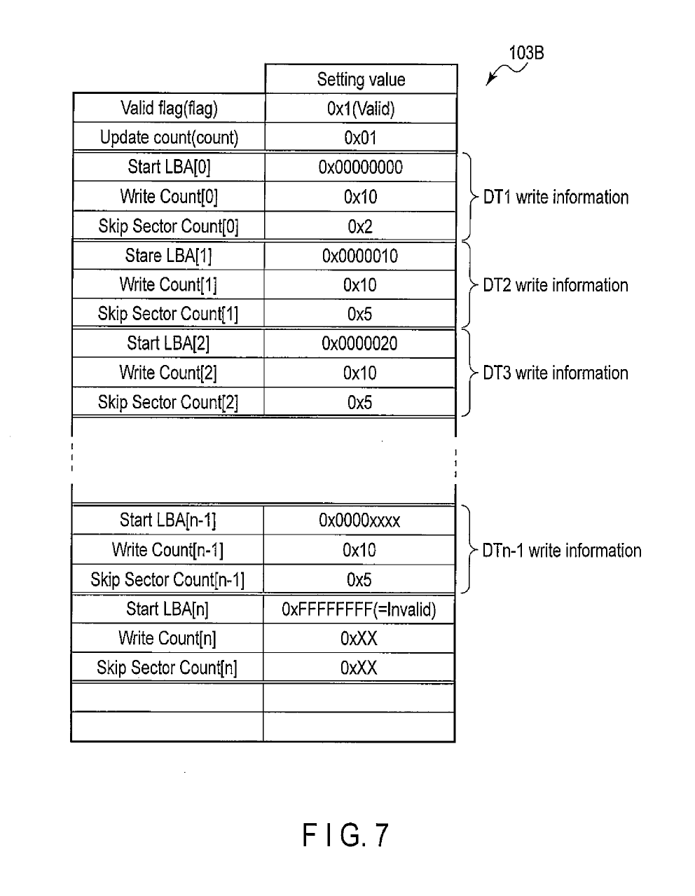

A configuration example of the write data management table 103B will be described below with reference to FIG. 7. The write data management table 103B holds a valid flag indicating that this write data management table 103B is valid.

The write data management table 103B stores write information associated with each write data block written in the specific area 501. Assume that write data blocks DT1 to DTn are written in the special area 501 by a single special write operation. In this case, pieces of write information corresponding to write data blocks DT1 to DTn are registered in the write data management table 103B.

Write information corresponding to one write data block includes three pieces of management information, that is, “Start LBA”, “Write Count”, and “Skip Sector Count”. Start LBA indicates a logical block address where a corresponding write data block is to be written. More specifically, Start LBA indicates a logical block address (start LBA) which designates a start storage location of a write block data. Write Count indicates a data size of a corresponding write data block, that is, the number of sectors (the number of blocks) required to store the corresponding write data block. Skip Sector Count indicates an interval (the number of sectors) between a storage location where a corresponding write data block is to be written and that where the immediately preceding write data block was written.

In order to prevent write information from being lost even when the disk drive 100 is suddenly shut down due to an electric power failure or the like, write data appended with the write information may be written in the special area.

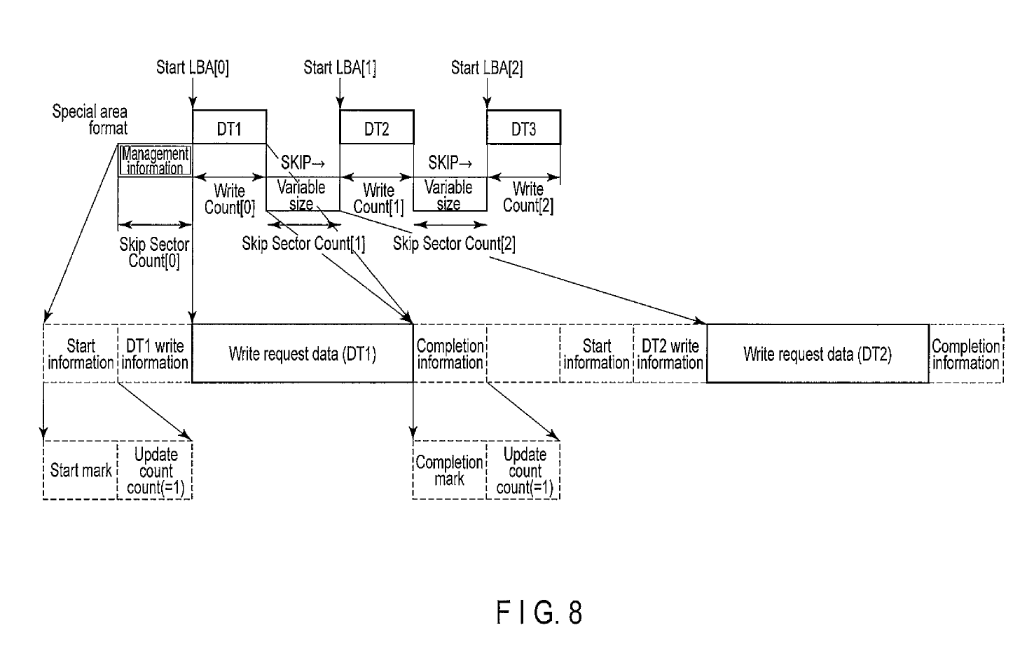

FIG. 8 shows an example of a format of write data blocks written in the special area.

Write data blocks DT1, DT2, DT3, . . . , DTn are written in a single track in the special area to be spaced apart from each other. Write data block DT1 has a data size (=10 sectors) indicated by Write Count[0] in FIG. 7. Write data block DT1 is written in a storage location skipped from a start block (start sector) in the special area by an interval (=2 sectors) indicated by Skip Sector Count[0] in FIG. 7. Write data block DT2 is written in a storage location skipped from the storage location (last sector) of write data block DT1 by an interval (=5 sectors) indicated by Skip Sector Count[1] in FIG. 7. Write data block DT2 has a data size (=10 sectors) indicated by Write Count[1] in FIG. 7. Write data block DT3 is written in a storage location skipped from the storage location (last sector) of write data block DT2 by an interval (=5 sectors) indicated by Skip Sector Count[2] in FIG. 7. Write data block DT3 has a data size (=10 sectors) indicated by Write Count[2] in FIG. 7.

Every time the write operation of each write data block (request data) in the special area is complete, the MPU 101 writes completion information (write completion information) in a sector in the special area immediately after a sector group in which this request data was written. The completion information indicates that the write operation of this write data block is normally complete. If an electric power failure has occurred in the middle of the write operation of a write data block, the completion information is not written in the special area. Hence, by writing the completion information in a storage location after a storage location of the write data block, wrong data can be prevented from being restored to the data storage area by the aforementioned restoration processing (write-back processing).

The completion information may include a completion mark indicating normal completion of the write operation, and an update count. The update count indicates the number of overwrite times on the special area, in other words, the number of times of execution of the special write accesses for a single special track.

Furthermore, the MPU 101 writes start information and the aforementioned write information in a sector immediately before a sector in which a start write data of a write data block is to be written. The start information may include a start mark indicating the start of the write operation of this write data block, and the aforementioned update count. In a sector immediately before a sector group in which write data block DT1 is to be written, the start information and write information of write data block DT1 are written. Likewise, in a sector immediately before a sector group in which write data block DT2 is to be written, the start information and write information of write data block DT2 are written.

For example, in a storage location corresponding to an interval (=5 sectors) between write data blocks DT1 and DT2, the completion information of write data block DT1 is written. Then, in a sector immediately before a storage location in which write data block DT2 is to be written, the start information and write information (Start LBA[1], Write Count[1], and Skip Sector Count[1]) of write data block DT2 are written.

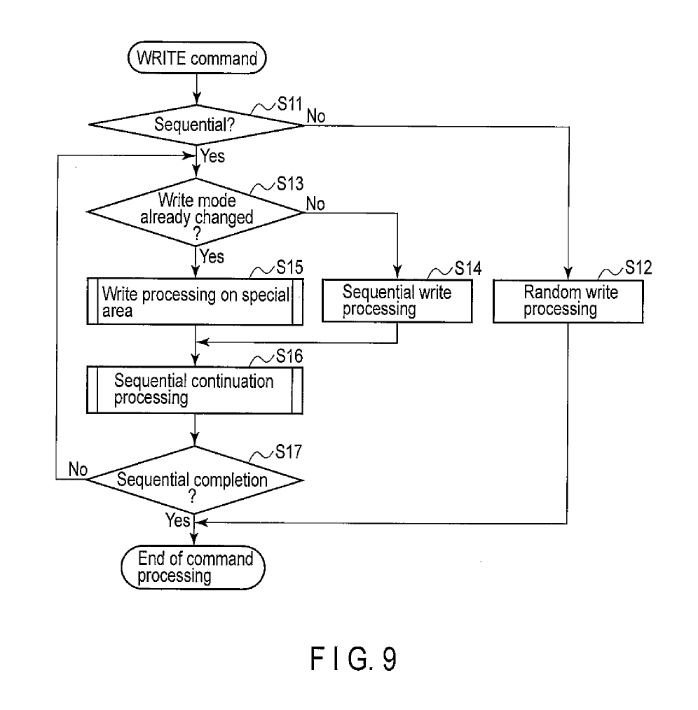

The sequence of the write processing executed by the disk drive 100 will be described below with reference to the flowchart shown in FIG. 9.

The MPU 101 of the disk drive 100 determines whether or not one or more write commands received from the host 10 are sequentially writable commands (step S11). If the number of command queues is set to be one, the MPU 101 determines in step S11 whether or not a new write command received from the host 10 is that which is logically continuous to the immediately preceding write command.

If one or more write commands received from the host 10 are not sequentially writable commands (NO in step S11), the MPU 101 executes random write processing (step S12). In step S12, write block data corresponding to each write command is written in a data storage position in the data storage area, to which a logical block address designated by this write command is assigned.

If one or more write commands received from the host 10 are sequentially writable commands (YES in step S11), the MPU 101 determines whether or not the write mode has already been changed to the special write mode (step S13). If the write mode is not changed, that is, if the current write mode is the sequential write mode (NO in step S13), the MPU 101 executes the sequential write processing (step S14). In step S14, the MPU 101 executes the aforementioned sequential write operation using the sequential write processing module 302. The sequential write processing module 302 writes write block data corresponding to a write command to be processed in a target storage location to which a logical block address designated by the write command to be processed is assigned.

If the write mode has already been changed, that is, if the current write mode is the special write mode (YES in step S13), the MPU 101 executes processing required to execute write accesses to the special area (step S15). In step S15, the MPU 101 executes the aforementioned special write operation using the special write processing module 303. Upon reception of a write data block corresponding to a write command to be processed, the special write processing module 303 writes that write data block in a quickest write-accessible storage location in the special area.

After the sequential write processing (step S14) or special write processing (step S15), the MPU 101 executes sequential write continuation processing (step S16). In the sequential write continuation processing, processing for changing the write mode from the sequential write mode to the special write mode, or the like is executed as needed.

The processes in steps S13 to S16 are repeated until processing of all sequentially writable write commands, which have already been received, is completed (step S17).

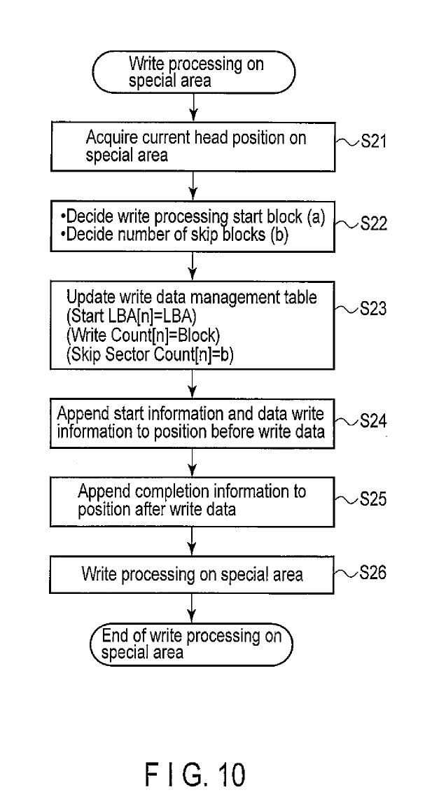

The special write accesses executed by the disk drive 100 in step S15 in FIG. 9 will be described below with reference to the flowchart shown in FIG. 10.

The MPU 101 positions the head 5 on the special area (special track). Then, the MPU 101 executes processing for acquiring the current position of the head 5 on the special area (step S21). In step S21, the MPU 101 detects the current position of the head 5 on the special track, that is, a sector number (block number) on the special track where the head 5 is positioned, in cooperation with the HDC 104.

The MPU 101 then decides a write processing start block corresponding to a target write data block (step S22). The write processing start block is a start storage location (start sector) where the target write data block is to be written. In step S22, the MPU 101 further decides the number of skip blocks (skip width) corresponding to the target write data block. The number of skip blocks (skip width) indicates an interval between the immediately preceding write data block (or a start block of the special area) and the target write data block.

Then, the MPU 101 updates the write data management table 103B to store write information (Start LBA, Write Count, and Skip Sector Count) corresponding to the target write data block in the write data management table 103B (step S23).

The MPU 101 appends start information and write information to a position before the target write data block and also completion information to a position after the target write data block, thereby generating a write data block having the format described above using FIG. 8 (steps S24 and S25). Then, the MPU 101 writes the generated write data block in the special area (step S26).

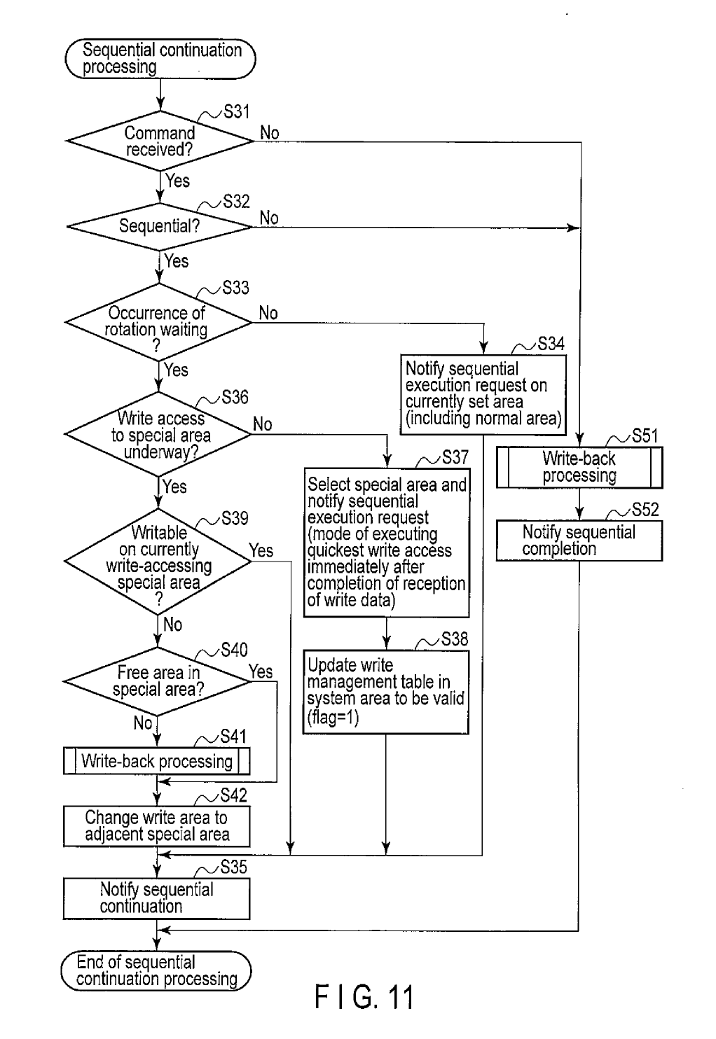

The sequential continuation processing executed by the disk drive 100 in step S16 in FIG. 9 will be described below with reference to the flowchart shown in FIG. 11.

If the MPU 101 receives a write command from the host 10 (step S31), it determines whether or not the received command is a sequentially writable command (step S32). If the received command is a sequentially writable command (YES in step S32), the MPU 101 determines whether or not the aforementioned rotation waiting state has occurred (step S33).

If no rotation waiting state occurs (NO in step S33), the MPU 101 notifies the sequential write processing module 302 of a sequential write execution request to execute the sequential write operation (step S34).

If the rotation waiting state has occurred (YES in step S33), the MPU 101 determines whether or not the write operation to the special area are currently performed, that is, whether or not the current write mode has been changed to the special write mode (step S36). If the current write mode is not the special write mode (NO in step S36), the MPU 101 selects the special write mode, and notifies the special write processing module 303 of a sequential execution request, so as to control the special write processing module 303 to execute special write operation (step S37). The special write operation is a write mode in which immediately after completion of reception of a write data block, this write data block is written in a quickest write-accessible storage location on the special area, as described above. The MPU 101 then sets a valid flag (flag=1) in the write data management table 103B in the system area or on the RAM 103, thus validating the write data management table 103B (flag=1) (step S38).

If the current write mode is the special write mode (YES in step S36), the MPU 101 checks whether or not a write data block is writable in the currently accessing special area, that is, whether or not a writable area remains in the currently accessing special area (step S39). If no writable area remains in the currently accessing special area (NO in step S39), the MPU 101 determines whether or not the special area includes a free area (another accessible special area), that is, whether or not another accessible special area is available (step S40). If another accessible special area is available (YES in step S40), the MPU 101 changes a write target special area from the currently accessing special area to another accessible special area (step S42). If a plurality of other accessible special areas are available, another accessible special area which is located in the vicinity of the currently accessing special area is selected as a write target special area.

If another accessible special area is not available (NO in step S40), the MPU 101 executes write-back processing so as to create a new accessible special area (step S41). Then, the MPU 101 changes a write target special area to the created new accessible special area (step S42).

The MPU 101 then notifies the special write processing module 303 that sequential processing (special write operation) is to be continued (step S35).

If no command (write command) is received from the host 10 (NO in step S31), or if the received command is not a sequentially writable command (NO in step S32), the MPU 101 may also execute the write-back processing (step S51). After execution of the write-back processing, the MPU 101 notifies the write module 300 that the sequential processing is complete (step S52).

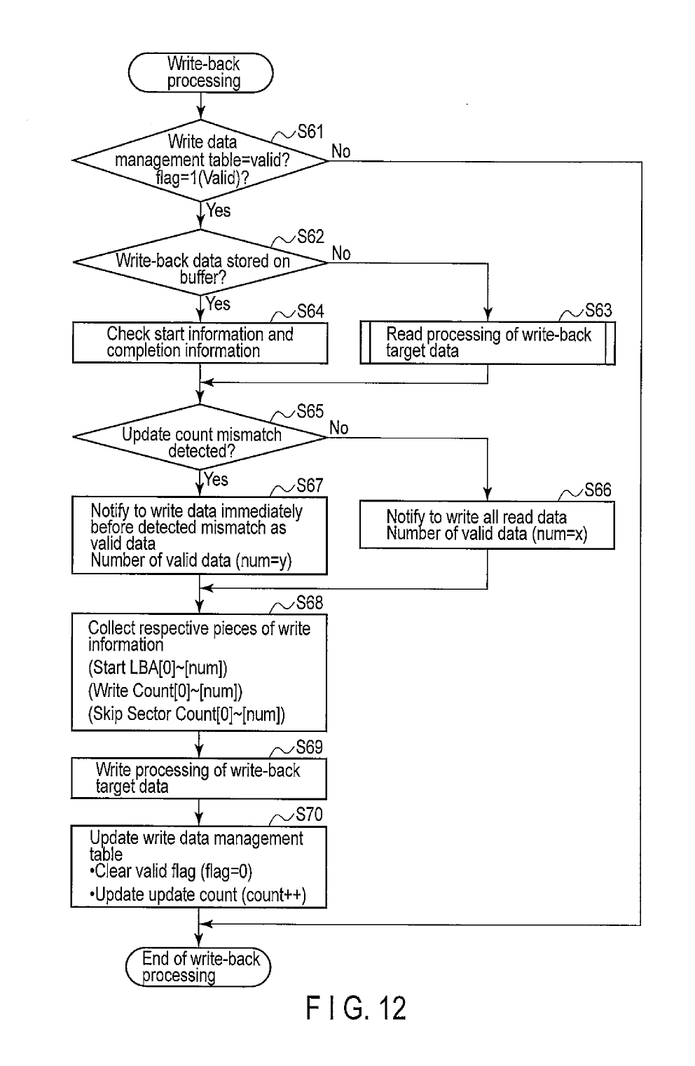

The sequence of the write-back processing (restoration processing) executed by the disk drive 100 in steps S41 and S51 in FIG. 11 will be described below with reference to the flowchart shown in FIG. 12.

The MPU 101 checks whether or not the write data management table 103B is valid, that is, whether or not the valid flag of the write data management table 103B is set (step S61). If the write data management table 103B is not valid (NO in step S61), the special area does not store any write data block to be written back to the data storage area. Therefore, the MPU 101 ends the write-back processing.

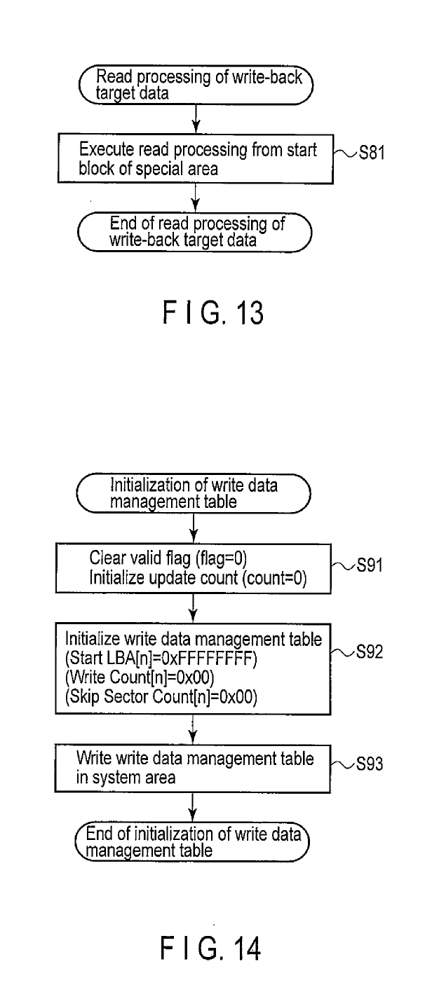

If the write data management table 103B is valid (YES in step S61), the MPU 101 determines whether or not all data (write-back target data) on the special area have already been loaded into the buffer 105 (step S62). If this loading is not performed yet (NO in step S62), the MPU 101 reads all the data (write-back target data) from the special area, and stores all the data in the buffer 105 (step S63). In step S63, as shown in step S81 in the flowchart shown in FIG. 13 (to be described later), the read processing is started from a start block (start sector) of the special area (special track). Then, all the data stored from the start block to the last block of the special area are read.

Then, the MPU 101 executes processing for extracting a valid data part (valid write data block group) from the data string loaded on the buffer 105 based on the aforementioned start information, completion information, and the skip width (Skip Sector Count) and the like in the write information (steps S64 to S68).

The MPU 101 checks all pieces of start information and all pieces of completion information (step S64) to determine whether or not the data string includes a boundary part, the update count of which does not match (step S65). If no boundary part, the update count of which does not match, is detected (NO in step S65), the MPU 101 specifies all the data included in the data string as a valid data part (step S66). On the other hand, if a boundary part, the update count of which does not match, is detected (YES in step S65), the MPU 101 specifies, as valid data parts, a data part which is included in the data string and is stored before the boundary part, the update count of which does not match (step S67).

After that, the MPU 101 collects respective pieces of write information in the valid data part, and executes setting processing for writing back respective write data blocks included in the valid data part to original storage locations (step S68). In step S68, the MPU 101 may generate, based on respective write information, list information indicating Start LBA, Write Count, and Skip Sector Count for each write data block in the valid data part. In this case, each Skip Sector Count value is used to exclude a data part corresponding to the skip width between neighboring write data blocks from the write-back target data. The write operations for writing write data blocks in the special area are executed by overwrite processing. For this reason, an old write data block, which has already been written back, may be stored in a data storage location corresponding to a skip width between neighboring write-back target write data blocks. Therefore, by excluding a data part corresponding to each skip width between neighboring write data blocks from the write-back target data, such old write data block can be prevented from being written back to the data storage area again.

Next, the MPU 101 writes, based on the generated list information, each write data block in a storage location on the data storage area, which starts with a sector to which Start LBA of that write data block is assigned (step S69). In this manner, each write data block can be written back to the original storage location. Then, the MPU 101 updates the write data management table 103B in the system area or on the RAM 103 (step S70). In step S70, the MPU 101 executes processing for invalidating the write data management table 103B by clearing the valid flag of the write data management table 103B. In step S70, the MPU 101 also executes processing for updating the update count value.

The sequence of the processing for reading all data (write-back target data) on the special area will be described below with reference to the flowchart shown in FIG. 13.

The MPU 101 reads all data stored in the special area, and stores the read data in the buffer 105 (step S81). In this step S81, the MPU 101 starts the processing for reading data from the special area from the start block (start sector) of the special area. Then, the MPU 101 sequentially reads all the data stored in respective sectors from the start block to the last block of the special area, and stores all these data in the buffer 105.

The sequence for initializing the write data management table 103B will be described below with reference to the flowchart shown in FIG. 14.

The MPU 101 clears the valid flag (flag) of the write data management table 103B to invalidate the write data management table 103B, and sets an update count (count) of the write data management table 103B to zero (step S91). Then, the MPU 101 initializes the contents (write information) of the write data management table 103B (step S92). In step S92, each Start LBA value is set to be an initial value (for example, 0xFFFFFFFF, where “0x” indicates hexadecimal notation). Also, each Write Count value and Skip Sector Count value are set to be an initial value (for example, 0x00). Then, the MPU 101 writes the initialized write data management table 103B in the system area on the disk 1 (step S93).

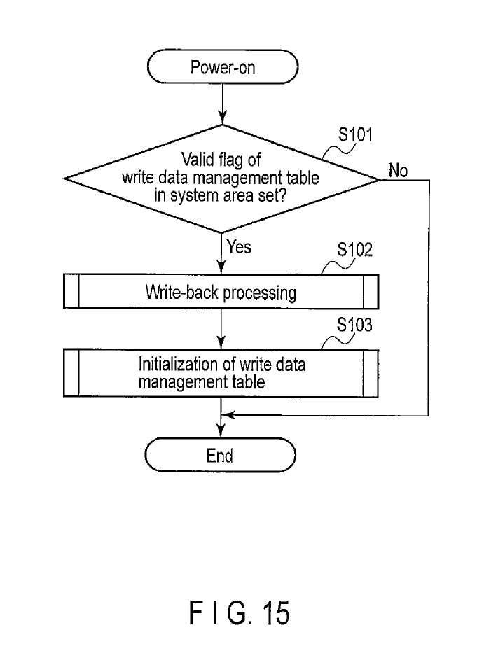

Processing to be executed at the power-on timing of the disk drive 100 will be described below with reference to the flowchart shown in FIG. 15.

The MPU 101 checks whether or not the valid flag of the write data management table 103B in the system area is set (flag=1) (step S101). If the flag is set (YES in step S101), since valid data (write data blocks) are stored in the special area, the MPU 101 executes the write-back processing described using FIG. 12 (step S102). After that, the MPU 101 executes the management table initialization processing described using FIG. 14 (step S103).

On the other hand, if the valid flag of the write data management table 103B in the system area is not set (flag=0) (NO in step S101), no valid data (write data block) is stored in the special area. Therefore, the MPU 101 skips execution of the processes in steps S102 and S103 above.

As described above, according to this embodiment, a plurality of write data blocks having continuous logical block addresses are written in a plurality of storage locations which are spaced apart from each other in the specific area (special area) on the disk. In this case, the head 5 is positioned on the specific area. Then, upon reception of a first write data block in the plurality of write data blocks, the first write data block is written in a first storage location adjacent to that position of the head 5. Upon reception of a second write data block having a second logical block address, which is logically continuous to a first logical block address corresponding to the first write data block, the second write data block is written in a second storage location adjacent to the position of the head 5. In this manner, each of the plurality of logically continuous write data blocks, which are sequentially writable, is written in a storage location in the special area, which location is adjacent to the current position of the head 5, irrespective of the LBA of that write data block. Therefore, even when the reception timing delay of each write data block has occurred, the waiting state in which the control waits until the target storage location reaches a position below the head 5 again never occurs, thus reducing a time required to write a plurality of logically continuous write data blocks. Hence, the sequential write performance of the disk drive 100 can be improved. In comparison to a case in which the sequential write operation is executed, the host 10 can be instantaneously notified of completion of write operations of the plurality of logically continuous write data blocks.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A disk drive comprising:
a disk;
a head configured to read data from and write data to the disk;
a rotation mechanism configured to rotate the disk; and
a write module configured to write a plurality of data blocks received from a host and comprising contiguous logical block addresses to a plurality of non-contiguous storage locations in an area on the disk,
wherein the write module is further configured to:
position the head on the area,
in response to receiving a first data block of the plurality of data blocks, write the first data block to a first storage location of the area, the first storage location adjacent to a position of the head, and
in response to receiving a second data block comprising a second logical block address logically contiguous to a first logical block address corresponding to the first data block, write the second data block in a second storage location of the area, the second storage location adjacent to the position of the head, and
wherein the second storage location comprises a storage location separated from the first storage location by an interval corresponding to a difference between a write completion time of the first data block and a reception time of the second data block.

2. The disk drive of claim 1,
wherein the write module comprises a first write mode for executing a sequential write operation to sequentially write the plurality of data blocks in contiguous data storage locations of a data storage area on the disk, and a second write mode for writing the plurality of write data blocks in the plurality of non-contiguous storage locations in the area on the disk, and wherein the write module is further configured to shift from the first write mode to the second write mode when a reception time delay of a specific data block in the plurality of data blocks is detected in the first write mode.

3. The disk drive of claim 1, further comprising a restoration module configured to restore the plurality of data blocks written in the plurality of storage locations to a data storage area on the disk based on logical block addresses of the plurality of data blocks.

4. The disk drive of claim 1, wherein the write module is further configured to write completion information indicating completion of writing of the first data block in a storage location in the area immediately after the first storage location in which the first data block is written, and to write completion information indicating completion of writing of the second data block in a storage location in the area immediately after the second storage location in which the second data block is written.

5. The disk drive of claim 1, wherein the area comprises one or more tracks on the disk.

6. The disk drive of claim 1, wherein the area comprises a first area and a second area, which are non-contiguous on the disk.

7. A write control method of writing a plurality of data blocks received from a host and comprising contiguous logical block addresses on a disk of a disk drive, the method comprising:
positioning a head on an area on the disk;
in response to receiving a first data block of the plurality of data blocks, writing the first data block to a first storage location of the area, the first storage location adjacent to a position of the head; and
in response to receiving a second data block comprising a second logical block address logically contiguous to a first logical block address corresponding to the first write block, writing the second data block in a second storage location of the area, the second storage location adjacent to the position of the head, and the second storage location comprising a storage location separated from the first storage location by an interval corresponding to a difference between a write completion time of the first data block and a reception time of the second data block.

8. The write control method of claim 7, further comprising:
executing a sequential write operation to sequentially write the plurality of data blocks in contiguous data storage locations of a data storage area on the disk when in a first write mode;
writing the plurality of data blocks in a plurality of non-contiguous storage locations in the area on the disk when in a second write mode; and
shifting from the first write mode to the second write mode when a reception time delay of a specific data block in the plurality of data blocks is detected in the first write mode.

9. The write control method of claim 7, further comprising restoring the plurality of data blocks written in the plurality of storage locations to a data storage area on the disk based on logical block addresses of the plurality of data blocks.

10. The write control method of claim 7,
wherein writing the first data block comprises writing completion information indicating completion of writing of the first data block in a storage location in the area immediately after the first storage location in which the first data block is written, and
wherein writing the second data block comprises writing completion information indicating completion of writing of the second data block in a storage location in the area immediately after the second storage location in which the second data block is written.

11. The write control method of claim 7, wherein the area comprises one or more tracks on the disk.

12. The write control method of claim 7, wherein the area comprises a first area and a second area, which are non-contiguous on the disk.
